(19) United States
(12) Patent Application Publication
(10) Pub. No.: US 2010/0262266 A1
(43) Pub. Date: Oct. 14, 2010

(54) AUTOMATIC AUDIO TRANSITION

(75) Inventors: Sheng-Chi Chang, Sinjhuang City (TW); Tsung-Kuei Lee, Lujhou City (TW); Shih-Chieh Ou, Taipei (TW); Da-Wei Kuo, Chungho City (TW); Henrik Telander, Shillin Taipei (TW)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/421,699

(22) Filed: Apr. 10, 2009

(51) Int. Cl. G06F 19/00

(52) U.S. Cl. 700/94

(57) ABSTRACT

A method may include receiving, at a device, a signal from a first audio source. Audio content may be output based on the received signal. It may be determined whether a signal strength of the received signal has dropped below a threshold. Audio content may be automatically output from a second audio source when the signal strength of the received signal has dropped below the threshold.

### TECHNICAL FIELD OF THE INVENTION

The invention relates generally to mobile devices and, more particularly, to outputting audio information from a mobile device.

### DESCRIPTION OF RELATED ART

A variety of modern mobile or portable devices may be capable of outputting or “playing” audio or audiovisual material. Such devices include conventional terrestrial radio devices, satellite-based radio devices, personal music or media players, Internet-based media players, etc. As the variety of devices and the capabilities included within the devices has increased, the available content has also increased.

### SUMMARY

According to a first aspect, a device-implemented method may include receiving, at a device, a signal from a first audio source; outputting audio content based on the received signal; determining whether a signal strength of the received signal has dropped below a threshold; and automatically outputting audio content from a second audio source when the signal strength of the received signal has dropped below the threshold.

Additionally, the first audio source may be located remotely from the device and the signal may be a radio frequency signal.

Additionally, the radio frequency signal may be an FM (frequency modulation) radio signal.

Additionally, the threshold may be about 50 dBu (decibels unloaded).

Additionally, the radio frequency signal may be a data stream received via a telecommunications network.

Additionally, the signal strength may be measured based on a packet loss, and the threshold may be a packet loss of more than about 5%.

Additionally, the method may include determining whether the signal strength of the received signal has dropped below the threshold for a particular amount of time.

Additionally, the particular amount of time may be about 10 seconds.

Additionally, the second audio source may be an audio file stored locally on the device.

Additionally, the second audio source may be a playlist of audio files stored locally on the device.

Additionally, the method may further include accessing audio source transition rule information, the audio source transition rule information including at least an initial audio source designation that designates the first audio source, and a backup audio source designation that designates the second audio source.

Additionally, the method may further include monitoring the signal strength from the first audio source following outputting the audio content from a second audio source; determining whether the signal strength exceeds the threshold; and outputting audio content based on the received signal when the signal strength exceeds the threshold.

Additionally, determining whether the signal strength exceeds the threshold may include determining whether the signal strength exceeds the threshold for a particular period of time.

Additionally, the particular period of time may be about 30-60 seconds.

According to another aspect, a device may include a communication interface for receiving a signal from a first audio source; a memory for storing an audio file; an output device to output audio content; and logic configured to output audio content via the output device based on the received signal; determine whether a signal strength of the received signal has dropped below a threshold; and automatically output audio content from the stored audio file when the signal strength of the received signal has dropped below the threshold.

Additionally, the first audio source may be located remotely from the device, and the signal may be an FM (frequency modulation) radio signal.

Additionally, the logic may be further configured to identify audio source transition rule information, the audio source transition rule information including at least an initial audio source designation that designates the first audio source, and a backup audio source designation that designates the stored audio file.

Additionally, the logic may be further configured to monitor the signal strength of the received signal from the first audio source following outputting the audio content from the stored audio file; determine whether the signal strength of the received signal exceeds the threshold; and output audio content based on the received signal when the signal strength of the received signal exceeds the threshold.

According to yet another aspect, a computer-readable medium having stored thereon a plurality of sequences of instructions which, when executed by at least one processor, may cause the at least one processor to access audio source transition rule information, the audio source transition rule information including at least an initial audio source designation that designates a first audio source, and a backup audio source designation that designates a second audio source; receive a wireless signal from the first audio source; output audio content based on the received signal; determine whether a signal strength of the received signal has dropped below a threshold; and automatically output audio content from the second audio source when the signal strength of the received signal has dropped below the threshold.

Additionally, the plurality of sequences of instructions which, when executed by the at least one processor, further cause the at least one processor to monitor the signal strength of the received signal from the first audio source following outputting the audio content from the second audio source; and determine whether the signal strength of the received signal exceeds the threshold; and output audio content based on the received signal when the signal strength of the received signal exceeds the threshold.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems consistent with the invention may be implemented;

FIG. 2 is a diagram illustrating components of the user device of FIG. 1 according to an exemplary implementation;

FIG. 3 is a functional block diagram of the user device of FIGS. 1 and 2;

FIG. 4 illustrates a structure of exemplary audio source transition rule database; and

FIG. 5 is a flow diagram illustrating exemplary processing associated with transitioning audio sources in the user device of FIG. 1.

### DETAILED DESCRIPTION

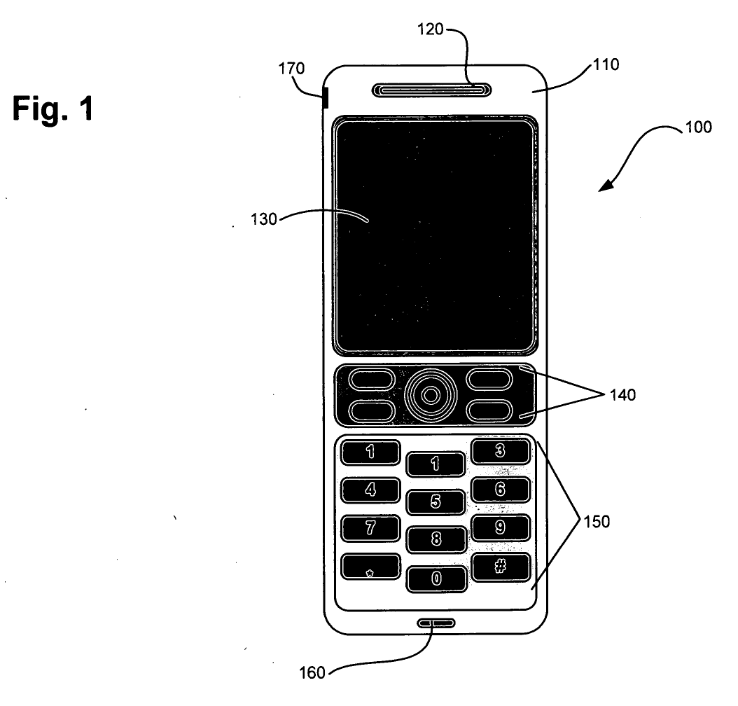

FIG. 1 is a diagram of an exemplary user device 100 which may be used in conjunction with devices, systems and methods described herein. In an exemplary implementation, user device 100 may be a mobile terminal. As used herein, the term “mobile terminal” may include a portable media player (PMP) (e.g., an MPEG audio layer 3 (MP3) player); a video game playing device; a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Referring to FIG. 1, user device 100 may include housing 110, speaker 120, display 130, control buttons 140, keypad 150, microphone 160, and audio/visual (A/V) interface port 170. Housing 110 may protect the components of user device 100 from outside or environmental elements. Speaker 120 may provide audible information to a user of user device 100.

Display 130 may provide visual information to the user. For example, display 130 may provide information regarding incoming or outgoing telephone calls and/or incoming or outgoing electronic mail (e-mail), instant messages, short message service (SMS) messages, etc. Control buttons 140 may permit the user to interact with user device 100 to cause user device 100 to perform one or more operations, such as place a telephone call, play various media, etc. For example, control buttons 140 may include a dial button, hang up button, play/pause button, etc. Keypad 150 may include a standard telephone keypad. Microphone 160 may receive audible information from the user. A/V interface port 170 may include a port or receptacle for receiving a terminal operatively connected to an external device, such as a hands free headset, headphones, an external display, a home or car audio system, etc.

Although user device 100, as depicted in FIG. 1, includes various elements, it should be noted that user device 100, consistent with embodiments described herein, may include fewer or additional elements than those depicted in FIG. 1. For example user device 100 may include a PMP having housing 110, display 130, control buttons 140, and A/V interface port 170, but not including one or more of keypad 150, speaker 120, or microphone 160.

Aspects of the invention are described herein with respect to outputting or “playing” audio content by a mobile device, such as user device 100. It should also be understood that devices, systems and methods described herein may also be used with other types of devices, such as a automobile-based stereo systems, etc., that may not include various communication functionality for communicating with other devices.

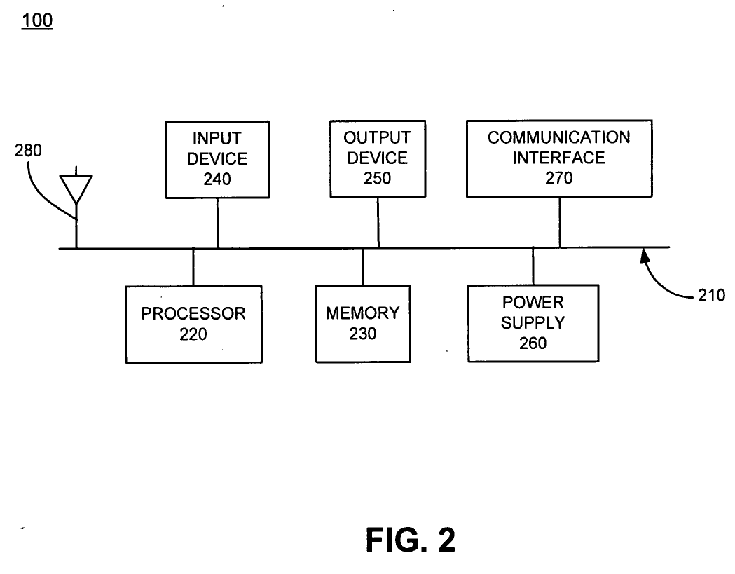

FIG. 2 is a diagram illustrating components of user device 100 according to an exemplary implementation. User device 100 may include bus 210, processor 220, memory 230, input device 240, output device 250, power supply 260, communication interface 270, and antenna 280. Bus 210 permits communication among the components of user device 100. One skilled in the art would recognize that user device 100 may be configured in a number of other ways and may include other or different elements. For example, user device 100 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of user device 100.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include mechanisms that permit an operator to input information to user device 100, such as control buttons 140, keypad 150, microphone 160, a keyboard (e.g., a QWERTY keyboard, a Dvorak keyboard), a gesture-based device, an optical character recognition (OCR) based device, a joystick, a virtual keyboard, a speech-to-text engine, a mouse, a pen, voice recognition and/or biometric mechanisms, etc.

Output device 250 may include one or more mechanisms that output information to the user, one or more speakers, such as speaker 120, an audio or audio visual interface, such as A/V interface port 170, a display, such as display 130, a printer, a wired or wireless headset (e.g., a Bluetooth® headset), etc.

Power supply 260, also referred to herein as battery 260, may include one or more batteries and/or other power source components used to provide power to user device 100. Communication interface 270 may include any transceiver-like mechanism that enables user device to communication with other devices. For example, communication interface 270 may include components for receiving terrestrial or satellite-based radio signals.

In other implementations, communication interface 270 may include components for transmitting and receiving analog and/or digital telecommunications signals, such as GSM (global system for mobile communications), PCS (personal communication services), FDMA (frequency division multiple access), CDMA (code division multiple access), TDMA (time division multiple access), GPRS (General Packet Radio Service), EDGE (Enhanced Data Rates for GSM Evolution), and/or HSDPA (high speed downlink packet access) signals. Additionally, communication interface 270 may include components for transmitting and receiving short range radio frequency (RF) signals associated with local data networks (e.g., Bluetooth®, Wi-Fi (e.g., IEEE 802.11x), or WiMAX (e.g., IEEE 802.16x) networks). For example, communication interface 270 may output audio signals to a Bluetooth® accessory or headset. Antenna 280 may include, for example, one or more directional and/or omnidirectional antennas. In one implementation, antenna 280 may be configured to receive over the air (OTA) radio frequency signals corresponding to frequency modulation (FM) and/or amplitude modulation (AM) broadcast radio signals.

User device 100 may provide a platform for a user to play music (e.g., output audio via speaker 120, AV interface port 170, or via communication interface 170 (e.g., a Bluetooth® accessory), make and receive telephone calls, send and receive messages (e.g., electronic mail, text messages, multi-media messages, short message service (SMS) messages, etc.), play games, etc. User device 100, as described in detail below, may also perform processing associated with enabling user device 100 to transition from one audio source to another audio source based on various predetermined factors. User device 100 may perform these operations in response to processor 220 executing sequences of instructions contained in a computer-readable medium, such as memory 230. Such instructions may be read into memory 230 from another computer-readable medium via, for example, communication interface 270. A computer-readable medium may include one or more memory devices. In alternative embodiments, hard-wired circuitry may be used in place of or in combination with software instructions to implement processes consistent with the invention. Thus, implementations described herein are not limited to any specific combination of hardware circuitry and software.

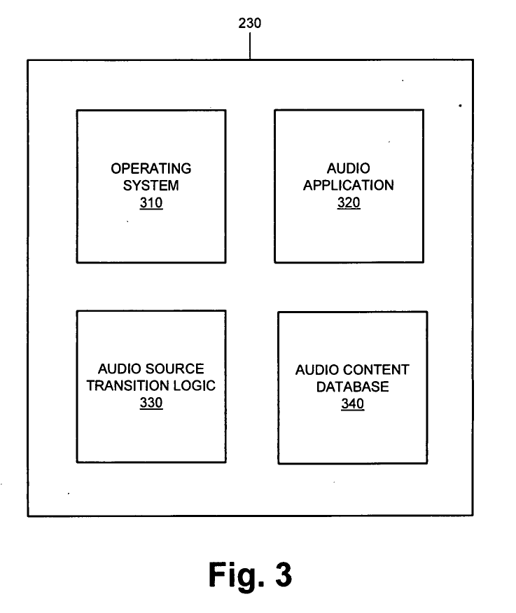

FIG. 3 is a functional block diagram of user device 100 of FIGS. 1 and 2. The logical blocks illustrated in FIG. 3 may be implemented in software, hardware, a combination of hardware and software. In one exemplary implementation, the logical blocks illustrated in FIG. 3 may be included in memory 230.

Referring to FIG. 3, memory 230 may include an operating system 310, an audio application 320, and audio source transition logic 330 executable by processor 220. Memory 230 may further include an audio content database 340. Depending on the implementation, user device 200 may include additional, fewer, or different components than those illustrated in FIG. 3. For example, audio application 320 may include more than one audio application (e.g., an FM radio application, a digital music player application, an Internet radio application, etc.).

Operating system 310 may include logic configured to manage hardware and software resources of user device 100. Operating system 310 may manage, for example, its file system, device drivers, communication resources (e.g., radio receiver(s), transmission control protocol (TCP)/IP stack), event notifications, etc. Audio application 320 may include logic configured to output or “play” at least two different types of audio content. As briefly described above, audio application 320 may include a single executable application or may include more than one executable application. For example, audio application 320 may include hardware and software components for outputting (e.g., via speaker 120 and/or AV interface port 170) FM (or AM) radio content and a second source of audio content, such as locally stored audio files, or audio content data streamed via a telecommunications network (e.g., Wi-Fi, GSM, UMTS (universal mobile telecommunications system), EVDO (evolution data only), HSDPA (High Speed Downlink Packet Access), etc.) (sometimes, audio content sources delivered via telecommunications networks are referred to as “Internet radio” or streaming audio). It should be noted that the term “Internet radio” may be used to describe any audio content streamed from a source remote from user device 100 and is not limited to “radio stations” or similarly formatted content sources.

In one implementation consistent with embodiments described herein, audio application 320 may be configured to provide a user interface for receiving user selections corresponding to audio playback. Such selections may include station (e.g., frequency) selection for FM radio playback, audio content library presentation for locally stored audio files, Internet radio source options for streamed audio content, etc. The user interface may further include playback controls, such as play/pause, stop, fast forward, back, reverse, next track, previous track, menu, etc. Alternatively, playback controls may be included in control buttons 140.

Audio application 320 may be further configured to receive a user selection of an audio source transition rule to be executed upon loss of audio content based, for example, on loss of connectivity to a source of the audio. For example, audio application 320 may be configured to receive an audio source transition rule designating a default playlist (i.e., a grouping a songs or other audio files) for playback in the event of a loss of FM radio signal and/or streamed audio content. In other implementations, the audio source transition rule may designate an Internet radio source to be activated in the event of a loss of FM radio signal. Similarly, the audio source transition rule may designate an FM radio station to be activated or “tuned into” in the event of a loss of an Internet radio. The selected audio source transition rule may be stored in, for example, audio content database 340, or other structure associated with memory 230.

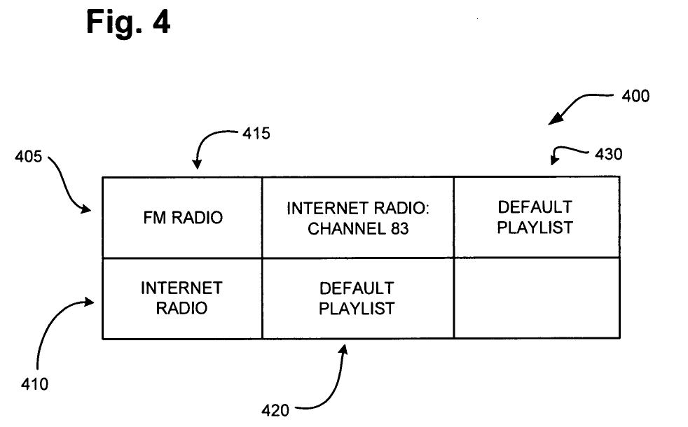

FIG. 4 illustrates a structure of exemplary audio source transition rule database 400. Audio source transition rule database 400 may be included in audio source transition logic 330 or may be located remotely from audio source transition logic 330, but may be accessible by audio source transition logic 330. As illustrated, audio source transition rule database 400 may include a number of rules corresponding to audio content sources. More specifically, audio source transition rule database 400 includes rule 405 corresponding to an FM radio content source and rule 410 corresponding to an Internet radio source. Each rule 405/410 may include an initial audio source field 415, first backup audio source field 420, and second backup audio source field 430.

Initial audio source field 415 may designate the source of the initial audio content. In rule 405, initial audio source field 415 designates FM radio, as the initial audio source. In rule 410, initial audio source field 415 designates Internet radio, as the initial audio source.

First backup audio source field 420 may designate an audio source to be played or output upon loss of audio content associated with the initial audio source field 415. In rule 405, first backup audio source field 420 designates a particular selection of an Internet radio source. In rule 410, first backup audio source field 420 designates a particular playlist or music track stored locally in user device 100 (e.g., in audio content database 340).

Second backup audio source field 430 may designate an audio source to be played or output upon failure to obtain audio content associated with the first backup audio source field 415. In rule 405, second backup audio source field 430 designates a particular playlist or music track stored locally in user device 100 (e.g., in audio content database 340). Rule 410 does not include an entry in second backup audio source field 430.

Returning to FIG. 3, audio source transition logic 330 may include logic configured to determine a loss in signal or connectivity corresponding to a current audio source. For example, for an FM radio audio source, audio source transition logic 330 may be configured to monitor a signal strength corresponding to the current FM radio audio source. In some implementations, signal strength monitoring may be incorporated into an FM radio receiver element integrated within communication interface 270. In other implementations, signal strength monitoring may be performed by other components within user device 100. For Internet radio or other stream audio sources, audio source transition logic 330 may be configured to monitor packet loss or some other form of data loss metric (e.g., jitter, delay, etc.).

Audio source transition logic 330 may be configured to identify a loss in signal or connectivity corresponding to a current audio source when a metric (e.g., signal strength, packet loss, etc.) falls below a predetermined threshold for a predetermined period of time. For example, an FM signal strength of less than approximately 50 dBu (unloaded decibels) for more than approximately 10 seconds may be considered a lost signal. For streamed audio sources, packet losses of, for example, more than 5% for 10 seconds may be considered unacceptably high and may be considered to be a loss of connectivity. The period of time may be considered to be a delay in which audio source transition logic 330 may determine that a signal has been lost. By requiring that the signal strength be reduced or lost for at least a predetermined period of time (e.g., 10 seconds), user device 100 may protect against unnecessary changes in audio content, such as upon momentary losses in signal such as short tunnels, interference, etc.

Upon detecting a loss in signal or connectivity, audio source transition logic 330 may be configured to retrieve or access the corresponding audio source transition rule (e.g., from database 400), and automatically transition audio playback to the first backup audio source as designated in the rule, so that audio playback from device 100 is substantially uninterrupted. In one implementation, audio playback from the first backup audio source may fade in, such that potentially unpleasant abrupt audio changes do not occur. The term “fade in” generally refers to a gradual increase in volume until the playback volume is brought to a normal or previously set volume level. In the event that a connection is not made to the first backup audio source, audio source transition logic 330 may be configured to transition to the second backup audio source (if designated). In some implementations, audio source transition logic 330 may be configured to output or display (e.g., on display 130) an indication or notification to the user corresponding to the transition.

In one exemplary implementation, audio source transition logic 330 may be configured to continue to monitor the signal or connectivity of the original audio source, such that, upon reaching acceptable signal or connectivity levels, device 100 may be transitioned back to the original audio content source. In some implementations, a determination regarding transition back to the original audio content source may require a determination of acceptable signal or connectivity levels for a predetermined test period, such as approximately 30-60 seconds. Such a safeguard prevents unnecessary toggling of audio sources in the event of spotty reception or changing conditions (e.g. geographic conditions, such as tunnels, etc.).

Audio content database 340 may include logic or memory structures configured to store or maintain audio files and/or audio source transition rules (e.g., database 400). In some implementations, audio content database 340 may include audio files sorted or stored as playlists, or groupings of audio files or content. In addition, audio content database 340 may be configured to store buffered streamed audio content prior to outputting by user device 100.

By enabling automatic transition from a first audio source to a backup audio source in the event of a loss of signal strength or connectivity to the first audio source, users of user device 100 may be provided with substantially uninterrupted audio content even in the event of signal related disturbances.

### Exemplary Processing

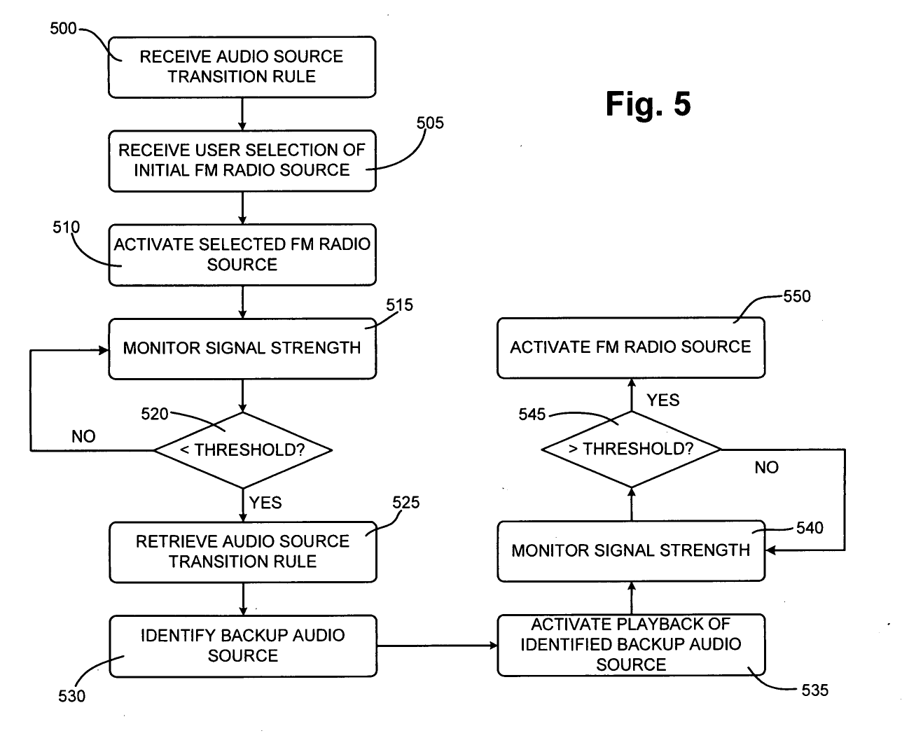

FIG. 5 is a flow diagram illustrating exemplary processing associated with transitioning audio sources in user device 100. Processing may begin with user device 100 receiving a user selection of an audio source transition rule (block 500). As described above, audio source transition rules may be established for dictating audio source transitions in the event of a loss of signal or connectivity associated with a selected audio source. For the purposes of this example, the audio source transition rule may indicate that a playlist “Easy Listening” may be selected as a backup audio source for an initial FM radio audio source.

User device 100 may receive a user selection of an initial FM radio audio source, such as a particular channel (i.e., frequency) (block 505). For example, audio application 320 may receive a user selection of an FM radio source and may further receive a user selection of the particular channel via a provided user interface (e.g., a radio control/input interface). User device may activate or “tune in to” the selected FM radio source (block 510). For example, audio application 320 may receive, via antenna 280, a radio frequency (RF) signal corresponding to the selected FM radio audio source.

User device 100 may monitor a signal strength associated with the FM radio source (block 515). For example, audio source transition logic 330 may monitor an unloaded decibel level (dBu) or other signal strength metric associated with the RF signal corresponding to the selected FM radio audio source. Audio source transition logic 330 may determine whether the signal strength of the FM radio source has dropped below a predetermined threshold for a predetermined period of time (block 520). For example, as described above, FM radio signals falling below 50 dBu for more than 10 seconds may be determined to be lost. As discussed above, this delay in implementing automatic audio transitions may protect against unnecessary and undesirable changes in audio due to momentary losses in audio signals.

If it is determined that the signal strength of the FM radio source has not dropped below a predetermined threshold for a predetermined period of time (block 520-NO), processing returns to block 520 for a next monitoring interval. However, when it is determined that the signal strength of the FM radio source has dropped below a predetermined threshold for a predetermined period of time (block 520-YES), audio source transition logic 330 may retrieve the audio transition rule corresponding to the initial audio source (e.g., from database 400) (block 525).

Audio source transition logic 330 may identify the backup audio source from the retrieved audio transition rule (block 530) and may activate playback of the selected backup audio source (block 535). In this scenario, assume that the identified backup audio source is the “Easy Listening” playlist identifying a selection of locally stored audio files. In this case, audio source transition logic 330 may automatically select and activate playback of one of the “Easy Listening” playlist files upon identification of a low signal strength of an FM radio source. In one embodiment, audio source transition logic may fade in the selected audio file.

As described above, in some embodiments, an audio transition rule may designate a remote audio source as a first backup source. In such an embodiment, audio source transition logic 330 may determine whether connectivity with the remote audio source is possible, and if not, may identify a second backup audio source from the audio transition rule.

While outputting the backup audio source, audio source transition logic 330 may continually monitor the signal strength of the FM radio source (block 540). Audio source transition logic 330 may determine whether the signal strength of the FM radio source has attained an acceptable signal level for a predetermined period of time (block 545). If not (block 545-NO), processing returns to block 540 for a next measurement interval. However, when the signal strength of the FM radio source has attained an acceptable signal level for a predetermined period of time (block 545-YES), audio transition logic 330 may transition playback back to the original FM radio source (block 550). In one implementation, audio source transition logic 330 may be configured to transition back to the FM radio source upon completion of a currently playing audio file, so as to not provide an abrupt change in audio content.

Although the processing of FIG. 5 has been described above in relation to an initial FM radio audio source, it should be understood that the embodiments described herein are equally applicable to any remote audio source, such as AM radio, Internet-based streaming audio sources, satellite radio sources, etc.

By enabling automatic transition from a first audio source to a backup audio source in the event of a loss of signal strength or connectivity to the first audio source, users of user device 100 may be provided with substantially uninterrupted audio content even in the event of signal related disturbances.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIG. 5, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Further, the phrase “based on” is intended to mean “based, at least in part, on” unless explicitly stated otherwise.

What is claimed is:

1. A device-implemented method, comprising:
receiving, at a device, a signal from a first audio source;
outputting audio content based on the received signal;
determining whether a signal strength of the received signal has dropped below a threshold; and
automatically outputting audio content from a second audio source when the signal strength of the received signal has dropped below the threshold.

2. The method of claim 1, wherein the first audio source is located remotely from the device and wherein the signal comprises a radio frequency signal.

3. The method of claim 2, wherein the radio frequency signal comprises an FM (frequency modulation) radio signal.

4. The method of claim 3, wherein the threshold comprises about 50 dBu (decibels unloaded).

5. The method of claim 2, wherein the radio frequency signal comprises a data stream received via a telecommunications network.

6. The method of claim 5, wherein the signal strength is measured based on a packet loss, and wherein the threshold comprises a packet loss of more than about 5%.

7. The method of claim 1, wherein determining whether a signal strength of the received signal has dropped below a threshold further comprises:
determining whether a signal strength of the received signal has dropped below the threshold for a particular amount of time.

8. The method of claim 7, wherein the particular amount of time comprises about 10 seconds.

9. The method of claim 1, wherein the second audio source comprises an audio file stored locally on the device.

10. The method of claim 9, wherein the second audio source comprises a playlist of audio files stored locally on the device.

11. The method of claim 1, further comprising:
accessing audio source transition rule information, the audio source transition rule information including at least an initial audio source designation that designates the first audio source, and a backup audio source designation that designates the second audio source.

12. The method of claim 1, further comprising:
monitoring the signal strength from the first audio source following outputting the audio content from a second audio source;
determining whether the signal strength exceeds the threshold; and
outputting audio content based on the received signal when the signal strength exceeds the threshold.

13. The method of claim 12, wherein determining whether the signal strength exceeds the threshold comprises determining whether the signal strength exceeds the threshold for a particular period of time.

14. The method of claim 13, wherein the particular period of time comprises about 30-60 seconds.

15. A device, comprising:
a communication interface for receiving a receiving a signal from a first audio source;
a memory for storing an audio file;
an output device to output audio content; and
logic configured to:
output audio content via the output device based on the received signal;
determine whether a signal strength of the received signal has dropped below a threshold; and
automatically output audio content from the stored audio file when the signal strength of the received signal has dropped below the threshold.

16. The device of claim 15, wherein the first audio source is located remotely from the device, and wherein the signal comprises an FM (frequency modulation) band radio signal.

17. The device of claim 15, wherein the logic is further configured to:
identify audio source transition rule information, the audio source transition rule information including at least an initial audio source designation that designates the first audio source, and a backup audio source designation that designates the stored audio file.

18. The method of claim 15, wherein the logic is further configured to:
monitor the signal strength of the received signal from the first audio source following outputting the audio content from the stored audio file;
determine whether the signal strength of the received signal exceeds the threshold; and
output audio content based on the received signal when the signal strength of the received signal exceeds the threshold.

19. A computer-readable medium having stored thereon a plurality of sequences of instructions which, when executed by at least one processor, cause the at least one processor to:
access audio source transition rule information, the audio source transition rule information including at least an initial audio source designation that designates a first audio source, and a backup audio source designation that designates a second audio source;
receive a wireless signal from the first audio source;
output audio content based on the received signal;
determine whether a signal strength of the received signal has dropped below a threshold; and
automatically output audio content from the second audio source when the signal strength of the received signal has dropped below the threshold.

20. The computer-readable medium of claim 19, wherein the plurality of sequences of instructions which, when executed by the at least one processor, further cause the at least one processor to:
monitor the signal strength of the received signal from the first audio source following outputting the audio content from the second audio source;
determine whether the signal strength of the received signal exceeds the threshold; and
output audio content based on the received signal when the signal strength of the received signal exceeds the threshold.
